(19) United States
(12) Patent Application Publication
(10) Pub. No.: US 2026/0260097 A1
(43) Pub. Date: Sep. 3, 2026

(54) METHOD AND DEVICE FOR PROCESSING DATA

(71) Applicant: Robert Bosch GmbH, Stuttgart (DE)

(72) Inventors: Claudius Glaeser, Ditzingen (DE); Florian Faion, Staufen (DE); Di Feng, Boeblingen (DE); Fabian Timm, Renningen (DE); Florian Drews, Renningen (DE); Jasmine Richter, Renningen (DE); Lars Rosenbaum, Lahntal (DE)

(21) Appl. No.: 18/832,190

(22) PCT Filed: Feb. 13, 2023
(86) PCT No.: PCT/EP2023/053417

§ 371 Date: Jul. 23, 2024

(30) Foreign Application Priority Data
Feb. 14, 2022 (DE) 10 2022 201 508.8

(51) Int. Cl. G06N 3/0464

(52) U.S. Cl. CPC G06N 3/0464

(57) ABSTRACT

A method for processing first data that are associated with at least one spatial region. The method includes: dividing the first data into at least one first partial data set, which is associated with a first part of the spatial region, and a second partial data set, which is associated with a second part of the spatial region, the second part of the spatial region being different at least in regions from the first part of the spatial region, transforming the second partial data set, for example on the basis of a reference between the second part of the spatial region and the first part of the spatial region, wherein a transformed second partial data set is obtained, evaluating the first partial data set and the transformed second partial data set by means of a detector for object detection.

### FIELD

The present invention relates to a method for processing first data associated with at least one spatial region.

The present invention further relates to a device for processing first data associated with at least one spatial region.

### SUMMARY

Exemplary embodiments of the present invention relate to a method, for example a computer-implemented method, for processing first data that are associated with at least one spatial region, for example sensor data, comprising the steps of: dividing the first data into at least one first partial data set, which is associated with a first part of the spatial region, and a second partial data set, which is associated with a second part of the spatial region, the second part of the spatial region being different at least in regions from the first part of the spatial region, transforming the second partial data set, for example on the basis of a reference between the second part of the spatial region and the first part of the spatial region, wherein a transformed second partial data set is obtained, evaluating the first partial data set and the transformed second partial data set by means of a detector for object detection. In this way, an efficient evaluation of the first partial data set and the transformed second partial data set is possible in further exemplary embodiments.

In further exemplary embodiments of the present invention, the evaluation of the first partial data set and the transformed second partial data set can, for example, be performed by means of the same detector for object detection or by the same instance of a detector for object detection, wherein, for example, the detector can already be trained.

In further exemplary embodiments of the present invention, the reference between the second part of the spatial region and the first part of the spatial region can, for example, be an angular position of the second part of the spatial region relative to the first part of the spatial region, for example relative to a reference point, for example a center point. For example, in further exemplary embodiments, a relevant part of the spatial region can be characterized in each case by at least one angle or solid angle or angular range or solid angular range.

In further exemplary embodiments of the present invention, the transformation can, for example, involve rotation, for example such that a reference axis of a second part of the spatial region is mapped onto a reference axis of another, for example first, part of the spatial region.

In further exemplary embodiments of the present invention, the transformation can, for example, involve mirroring, for example such that a reference axis of a second part of the spatial region is mapped onto a reference axis of another, for example first, part of the spatial region.

In further exemplary embodiments of the present invention, a transformation other than the exemplary transformations mentioned above (rotating, mirroring) can also be used for transforming.

In further exemplary embodiments of the present invention, for example, the detector can be trained for object detection by means of, for example, a conventional training method for, for example, the first part of the spatial region (or, for example, any part of the spatial region (for example the second part of the spatial region), wherein the any part of the spatial region is, for example, smaller than the (entire) spatial region), and the detector trained in this manner can be used in further exemplary embodiments, for example not only for evaluating the first partial data set but also for evaluating the transformed second partial data set, for example in particular without the detector being modified, for example further trained, for evaluating the transformed second partial data set, for example relative to the evaluation of the first partial data set.

In further exemplary embodiments of the present invention, the detector comprises at least one, for example artificial, for example deep, neural network, for example of the CNN (convolutional neural network) type (neural network based on convolutional operations), for example of the RPN (region proposal network) type.

In further exemplary embodiments of the present invention, an RPN, which is not based on CNN for example, can also be provided for the detector.

In further exemplary embodiments of the present invention, the RPN is designed to ascertain, on the basis of the first data, for example for defined positions (“anchors”) , for example in the region of a reference object, for example around a reference object such as a vehicle, whether an object is located in the vicinity of the anchors. In further exemplary embodiments, the RPN is designed to ascertain a first parameter, for example an “objectness score,” for at least one, for example a plurality of, for example all, anchors, which characterizes a confidence of the RPN for the presence of an object at the relevant position. In further exemplary embodiments, if an object is detected in the vicinity of an anchor in this way, the RPN can additionally ascertain its spatial extent, for example by estimating it, for example in the form of a bounding box.

In further exemplary embodiments of the present invention, it is provided that the first data comprise at least one of the following elements: a) data from a lidar sensor device, for example characterizable by a point cloud, b) data from a radar sensor device, c) data from an image sensor, for example digital image data. In further exemplary embodiments, a different type of sensor, for example for a surrounding area such as that of a vehicle, can be used as an alternative or in addition to the types of sensor devices mentioned above by way of example.

In further exemplary embodiments of the present invention, it is provided that the method comprises: transforming a detection result associated with the transformed second partial data set, for example on the basis of the reference between the second part of the spatial region and the first part of the spatial region, wherein, for example, a transformed second detection result is obtained.

In other words, in further exemplary embodiments of the present invention, a known transformation can be used for the data of, for example, a second area, which maps them in such a way that they behave like the data from, for example, a first area.

In further exemplary embodiments of the present invention, it is provided that the method comprises: aggregating the transformed second detection result with a first detection result which is associated with the first partial data set.

In further exemplary embodiments of the present invention, it is provided that the method comprises: dividing the first data into n many partial data sets, where n>1, which in each case are associated with an nth part of the spatial region, transforming a first number N1 of the n many partial data sets, wherein N1 many transformed partial data sets are obtained evaluating a first partial data set of the n many partial data sets and at least one, for example all, transformed partial data sets of the N1 many transformed partial data sets by means of the, for example the same, detector.

In further exemplary embodiments of the present invention, it is provided that the method comprises at least one of the following elements: a) transforming detection results associated with the N1 many transformed partial data sets, wherein, for example, in each case a transformed second detection result is obtained, b) aggregating the transformed second detection results with a first detection result which is associated with the first partial data set of the n many partial data sets. This makes possible, for example, an efficient representation and, if necessary, further processing of the detection results associated with different parts of the spatial region.

In further exemplary embodiments of the present invention, it is provided that the transformation comprises a rotation, for example about a reference point, for example the center point, of a sensor device providing the first data. For example, in some embodiments, the sensor device can be designed as a lidar sensor device as already described above, and the reference point can, for example, characterize a center point of the lidar sensor device.

In further exemplary embodiments of the present invention, at least one other known transformation can be used as an alternative to or in addition to rotation.

In further exemplary embodiments of the present invention, it is provided that the first data associated with the spatial region are associated with an angle of 360° (for example in a virtual plane parallel to a ground such as a road surface), wherein an nth part of the spatial region is associated with an angle of 360°/n. In further exemplary embodiments, such a division of the spatial region can be used, for example, when using a lidar sensor device for a vehicle, for example a motor vehicle, for example in order to obtain four parts of the spatial region, in each case at least approximately 90° in size, for example around the vehicle. In this way, for example a surrounding area of the vehicle can be efficiently subdivided into a plurality of corresponding parts of the spatial region, wherein the partial data sets associated with a relevant part of the spatial region can be efficiently processed on the basis of the principle according to the embodiments.

In further exemplary embodiments of the present invention, it is provided that the first data associated with the spatial region is associated with a sum angle of x° (for example in a virtual plane parallel to a ground such as a road surface), wherein an nth part of the spatial region is associated with an angle of (x/n)°, where x<>360. In other words, in further exemplary embodiments, the spatial region can also be associated with an angle other than 360°, for example less than 360° or more than 360°, wherein, for example, the corresponding parts of the spatial region correspond to respective portions of the (entire) spatial region of x°.

Further exemplary embodiments of the present invention relate to a device for performing the method according to the embodiments of the present invention.

Further exemplary embodiments of the present invention relate to a vehicle, for example a motor vehicle, with at least one device according to the embodiments of the present invention.

Further exemplary embodiments of the present invention relate to a computer-readable storage medium comprising commands that, when executed by a computer, cause said computer to perform the method according to the embodiments of the present invention.

Further preferred embodiments of the present invention relate to a computer program comprising commands that, when the program is executed by a computer, cause said computer to perform the method according to the embodiments of the present invention.

Further exemplary embodiments of the present invention relate to a data carrier signal that transmits and/or characterizes the computer program according to the embodiments of the present invention.

Further exemplary embodiments of the present invention relate to a use of the method according to the embodiments of the present invention and/or of the device according to the embodiments of the present invention and/or of the vehicle according to the embodiments of the present invention and/or of the computer-readable storage medium according to the embodiments of the present invention and/or of the computer program according to the embodiments of the present invention and/or of the data carrier signal according to the embodiments of the present invention, for at least one of the following elements: a) spatial compression, b) specialization of the detector, c) saving a capacity of the detector, d) reducing network parameters (for example of at least one deep neural network) of the detector, for example a reduction of a number of trainable network parameters, for example a number of convolution kernels and/or a number of network levels or layers of the detector, e) increasing the performance of the detector, f) controlling an overlap of partial data sets, for example with respect to mutually adjacent parts of the spatial region, g) use of a detector, for example one that has already been trained, for a spatial region larger for example than the spatial region for which the detector has already been trained, wherein, for example, the detector is not changed for use, i.e. for example is left unchanged, h) recognition of objects, for example for at least one application in vehicles, for example driver assistance systems, i) recognition of objects for robotics and/or cyber-physical systems, j) recognition of objects for security technology.

Further features, possible applications and advantages of the present invention will be apparent from the following description of exemplary embodiments of the present invention shown in the figures. In this case, all of the features described or shown form the subject matter of the present invention individually or in any combination, irrespective of their wording or representation in the description herein or in the figures.

### BRIEF DESCRIPTION OF THE DRAWINGS

FIG. 1 schematically shows a simplified flowchart according to exemplary embodiments of the present invention.

FIG. 2 schematically shows a simplified flowchart according to further exemplary embodiments of the present invention.

FIG. 3 schematically shows a simplified block diagram according to further exemplary embodiments of the present invention.

FIG. 4 schematically shows a simplified block diagram according to further exemplary embodiments of the present invention.

FIG. 5 schematically shows a simplified block diagram according to further exemplary embodiments of the present invention.

FIG. 6 schematically shows simplified diagrams according to further exemplary embodiments of the present invention.

FIG. 7 schematically shows simplified diagrams according to further exemplary embodiments of the present invention.

FIG. 8 schematically shows a simplified block diagram according to further exemplary embodiments of the present invention.

FIG. 9 schematically shows aspects of uses according to further exemplary embodiments of the present invention.

FIG. 10 schematically shows aspects of a region proposal network according to further exemplary embodiments of the present invention.

### DETAILED DESCRIPTION OF EXAMPLE EMBODIMENTS

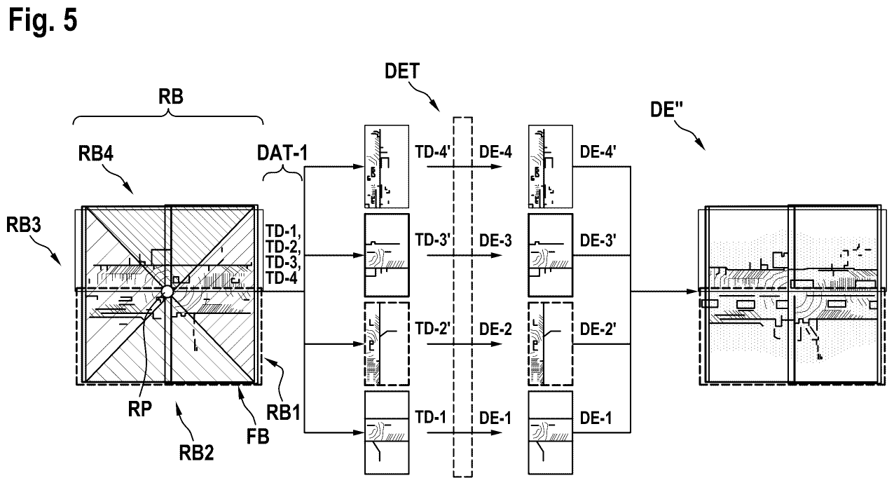

Exemplary embodiments, cf. FIGS. 1 and 5, relate to a method, for example a computer-implemented method, for processing first data DAT-1 (FIG. 1) associated with at least one spatial region RB (FIG. 5), for example sensor data, comprising: dividing 100 the first data DAT-1 into at least one first partial data set TD-1 associated with a first part RB-1 (FIG. 5) of the spatial region RB, and a second partial data set TD-2 associated with a second part RB-2 of the spatial region RB, the second part RB-2 of the spatial region RB being different at least in regions from the first part RB-1 of the spatial region, transforming 102 (FIG. 1) the second partial data set TD-2, for example on the basis of a reference between the second part RB-2 of the spatial region and the first part RB-1 of the spatial region RB, wherein a transformed second partial data set TD-2′ is obtained, evaluating 104 the first partial data set TD-1 and the transformed second partial data set TD-2′ by means of a detector DET for object detection. In this way, an efficient evaluation 104 of the first partial data set TD-1 and of the transformed second partial data set TD-2′ is possible in further exemplary embodiments.

In further exemplary embodiments, the evaluation 104 of the first partial data set TD-1 and of the transformed second partial data set TD-2′ can, for example, be performed by means of the same detector DET for object detection or by a same instance of a detector for object detection, wherein, for example, the detector DET can already be trained. The evaluation 104 leads, for example, to respective detection results DE-1, DE-2.

In further exemplary embodiments, for example, different partial data sets can be evaluated in succession by means of the same detector DET. In further exemplary embodiments, for example, different partial data sets can be evaluated at least partially overlapping in time or simultaneously by means of a plurality of instances of the detector DET, wherein the plurality of instances of the detector DET can require more computing time resources compared to a single instance or a single (same) detector DET, which evaluates the different partial data sets successively.

In further exemplary embodiments, the principle according to the embodiments can be understood or referred to for example as spatial compression, because for example an (entire) spatial region RB is mapped onto a smaller part or partial spatial region, for example in relation to the evaluation by the detector DET.

In further exemplary embodiments, the reference between the second part RB-2 (FIG. 5) of the spatial region RB and the first part RB-1 of the spatial region RB can, for example, be an angular position of the second part RB-2 of the spatial region RB relative to the first part RB-1 of the spatial region, for example relative to a reference point RP, for example a center point. For example, in further exemplary embodiments, each part RB-1, RB-2 of the spatial region RB can be characterized in each case by at least one angle or solid angle or angular range or solid angular range.

The spatial region RB shown by way of example in FIG. 5 is, for example, a surrounding area of the reference point RP, which characterizes an angular range (for example in a plane) of 360°. By way of example, in the present case, the spatial region RB is divided into n=4 sub-regions RB-1, RB-2, RB-3, RB-4, in each case characterizing for example approximately 90°.

In further exemplary embodiments, for example, the detector DET (FIG. 1, FIG. 5) can be trained for object detection by means of, for example, a conventional training method for, for example, the first part RB-1 (FIG. 5) of the spatial region RB (or, for example, any part of the spatial region RB (for example the second part RB-2 of the spatial region), wherein the any part of the spatial region RB is, for example, smaller than the (entire) spatial region RB), and the detector trained in this manner can be used in further exemplary embodiments, for example, not only for evaluating the first partial data set TD-1 but also for evaluating the transformed second partial data set TD-2′, for example in particular without the detector being modified, for example further trained, for evaluating the transformed second partial data set, for example relative to evaluating the first partial data set.

In further exemplary embodiments, the detector DET comprises at least one, for example artificial, for example dense, neural network, for example of the CNN (convolutional neural network) type (neural network based on convolutional operations), for example of the RPN (region proposal network) type.

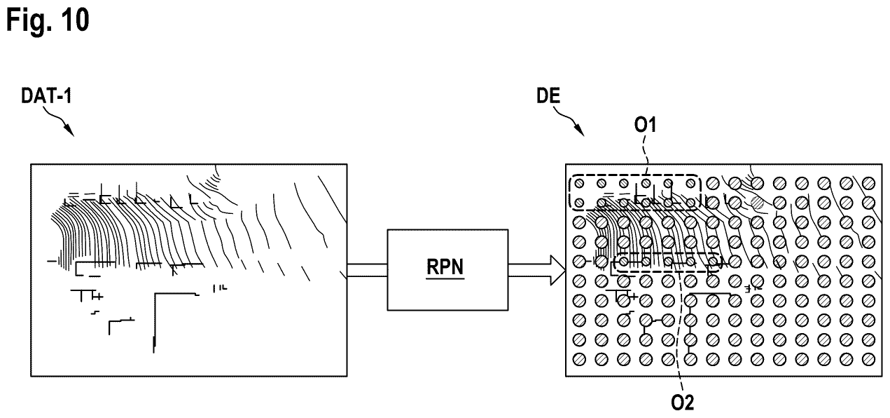

In further exemplary embodiments, see FIG. 10, the region proposal network RPN is designed to ascertain, on the basis of the first data DAT-1 or on the basis of the corresponding partial data sets TD-1, TD-2, . . . , for example for defined positions (“anchors”), for example in the region of a reference object, for example around a reference object such as, for example, a vehicle, see for example the reference point RP according to FIG. 5, whether an object is located in the vicinity of the anchors. In further exemplary embodiments, the region proposal network RPN is designed to ascertain a first parameter, for example an “objectness score,” for at least one, for example a plurality of, for example all, anchors, which characterizes a confidence of the region proposal network RPN for the presence of an object at the relevant position. In further exemplary embodiments, if an object is detected in the vicinity of an anchor in this way, the region proposal network RPN can additionally ascertain its spatial extent, for example by estimating it, for example in the form of a bounding box. For this purpose, FIG. 10 schematically shows by way of example the first data DAT-1, which can be fed to the detector designed as a region proposal network RPN, along with a detection result DE, which the detector RPN ascertains therefrom and which can have information about detected objects O1, O2, for example in the form of the aforementioned bounding boxes.

In further exemplary embodiments, FIG. 5, the detector DET, RPN can execute the sequence shown schematically in FIG. 10 by way of example for a plurality of (possibly transformed) partial data sets TD-1, TD-2, TD-3, TD-4, wherein, for example, in each case the same detector DET, RPN can be used.

In further exemplary embodiments, FIG. 4, it is provided that the first data DAT-1 comprise at least one of the following elements: a) data DAT-LID from a lidar sensor device, for example characterizable by a point cloud, b) data DAT-RAD from a radar sensor device, c) data DAT-IMAGE from an image sensor, for example digital image data.

In further exemplary embodiments, FIG. 1, it is provided that the method comprises: transforming 106 a detection result DE-2 associated with the transformed second partial data set TD-2′, for example on the basis of the reference between the second part RB-2 of the spatial region RB and the first part RB-1 of the spatial region RB, wherein, for example, a transformed second detection result DE-2′ is obtained. By means of the transformation 106, the effect of the transformation 102′ can, in relation to the second detection result DE-2, be compensated for, as it were, for example “undone,” such that after the transformation 106, the detection results DE-1 and DE-2′ in each case have the same relation to a reference, for example, to the first detection result DE-1. In further exemplary embodiments, it is thus advantageously possible to use the same detector DET, RPN for an evaluation of data associated with different parts RB-1, RB-2, . . . of the spatial region RB, although the respective partial data sets TD-1, TD-2, . . . Correspond, for example, to different angular ranges of the spatial region RB. In addition, the detection results DE-1, DE-2′ can be evaluated efficiently, for example in each case in a comparable manner.

In further exemplary embodiments, FIG. 1, it is provided that the method comprises: aggregating 108 the transformed second detection result DE-2′ with a first detection result DE-1 associated with the first partial data set TD-1. In further exemplary embodiments, this advantageously makes possible an efficient joint evaluation (not shown) of the detection results DE-1, DE-2′.

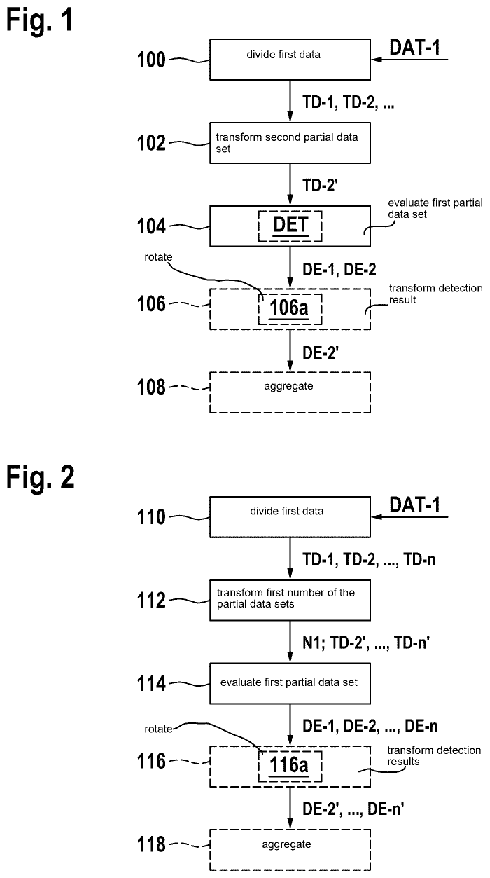

In further exemplary embodiments, FIGS. 2, 5, it is provided that the method comprises: dividing 110 the first data DAT-1 into n many, where n>1 (see FIG. 5 for an exemplary scenario where n=4), partial data sets TD-1, TD-2, . . . , TD-n, which in each case are associated with an nth part of the spatial region RB, transforming 112 a first number N1 of the n many partial data sets TD-2, . . . , TD-n, wherein N1 many transformed partial data sets TD-2′, . . . , TD-n′ are obtained, evaluating 114 a first partial data set TD-1 of the n many partial data sets and at least one, for example all, transformed partial data sets TD-2′, TD-n′ of the N1 many transformed partial data sets by means of the, for example the same, detector DET. In the example in FIG. 5 where n=4, this leads to the four detection results DE-1, DE-2, DE-3, DE-4.

In further exemplary embodiments, FIG. 2, it is provided that the method comprises at least one of the following elements: a) transforming 116 detection results DE-2, DE-n associated with the N1 many transformed partial data sets (for example, for FIG. 5 DE-2, , . . . , DE-4), wherein, for example, in each case a transformed second detection result DE-2′, . . . , DE-n′ (for example, for FIG. 5 DE-2′, DE-3′, DE-4′) is obtained, b) aggregating 118 (FIG. 2) the transformed second detection results DE-2′, . . . , DE-n′ with a first detection result DE-1, which is associated with the first partial data set TD-1 of the n many partial data sets. This makes possible, for example, an efficient representation and, if necessary, further processing of the detection results associated with different parts RB-1, RB-2, RB-3, RB-4 of the spatial region RB, see for example the reference sign DE″ according to FIG. 5.

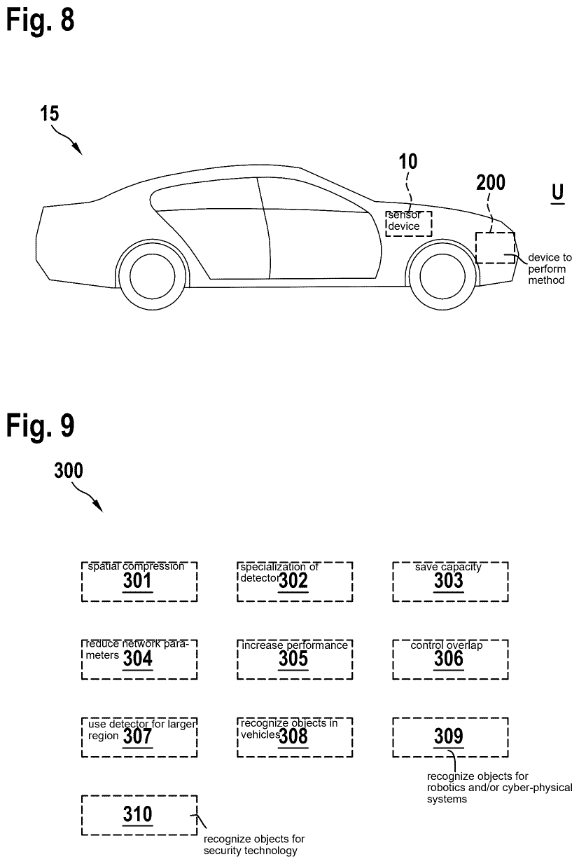

In further exemplary embodiments, FIGS. 1, 2, it is provided that the transformation 106, 116 comprises a rotation 106a, 116a, for example about a reference point RP (FIG. 5), for example the center point, of a sensor device 10 (FIG. 8) providing the first data DAT-1. For example, in some embodiments, the sensor device 10 can be designed as a lidar sensor device as already described above, and the reference point can, for example, characterize a center point of the lidar sensor device.

In further exemplary embodiments, it is provided that the first data DAT-1 associated with the spatial region RB are associated with an angle of 360° (for example, in a virtual plane parallel to a ground such as a road surface), wherein an nth part of the spatial region is associated with an angle of 360°/n. This is shown by way of example for n=4 in FIG. 5. In further exemplary embodiments, such a division of the spatial region RB can be used, for example, when using a lidar sensor device 10 (FIG. 8) for a vehicle, for example a motor vehicle 15, for example in order to obtain four parts RB-1, RB-2, RB-3, RB-4 (FIG. 5) of the spatial region RB, in each case at least approximately 90° in size, for example around the vehicle 15 (FIG. 8). In this way, for example, a surrounding area U of the vehicle 15 can be efficiently subdivided into a plurality of corresponding parts of the spatial region RB, wherein the partial data sets TD-1, TD-2, TD-3, TD-4 associated with a relevant part of the spatial region can be efficiently processed on the basis of the principle according to the embodiments.

In further exemplary embodiments, it is provided that the first data DAT associated with the spatial region RB is associated with a sum angle of x° (for example, in a virtual plane parallel to a ground such as a road surface), wherein an nth part of the spatial region RB is associated with an angle of (x/n), where x<>360. In other words, in further exemplary embodiments, the spatial region RB can also be associated with an angle other than 360°, for example less than 360° or more than 360°, wherein for example the corresponding parts of the spatial region correspond to respective portions of the (entire) spatial region of x°.

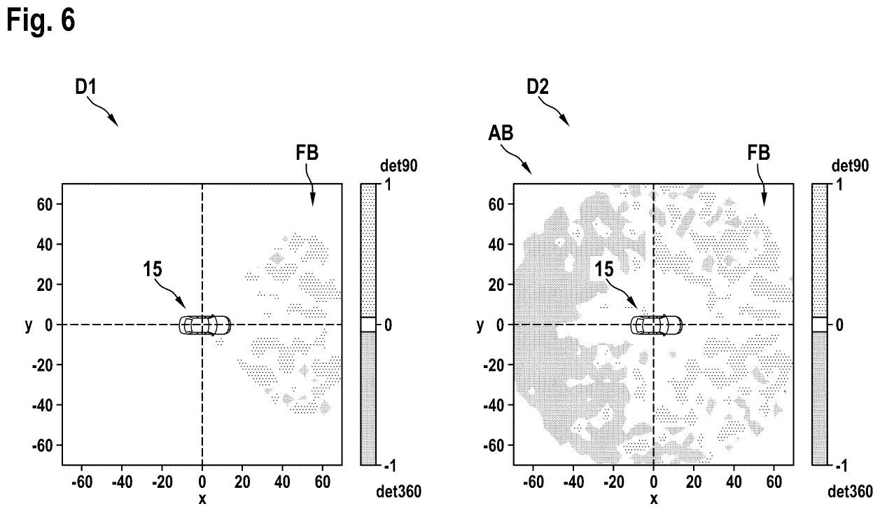

FIG. 6 schematically shows two diagrams D1, D2 for comparing the detector performance of, for example, conventional detectors for object detection in the context of a lidar sensor device for a motor vehicle. A first detector of the RPN type has been trained for an entire 360° field of view of an exemplary lidar sensor device 10 (“det360”), and a second detector of the RPN type has been trained for an angular range of 90° of the entire field of view (“det90”).

Diagram D1 shows a detector performance according to the mean average precision (MAP) metric for an evaluation in a 90° angular range, in which the second detector “det90” has been trained. The shading type assigned to the reference symbol det90 indicates spatial regions in which the second detector det90 has a higher detector performance according to the mAP metric, and the shading type assigned to the reference symbol det360 indicates spatial regions in which the first detector det360 has a higher detector performance according to the mAP metric. In the entire 90° angular range of diagram D1, the second detector “det90” is better than the first detector det360 as regards the MAP metric, which indicates that the second detector det90 has specialized better in the restricted field of view.

Diagram D2 shows a representation comparable to diagram D1, but now for an evaluation in the entire 360° field of view. As already shown in diagram D1, the specialized second detector det90 is also better than the first detector det360 in the 90° frontal region FB in diagram D2, but has a significantly weaker mAP in the other regions AB, in particular “behind” (to the left of) the vehicle 15 in FIG. 6, which is due to a lack of equivariance (both rotational and translational equivariance) of RPNS.

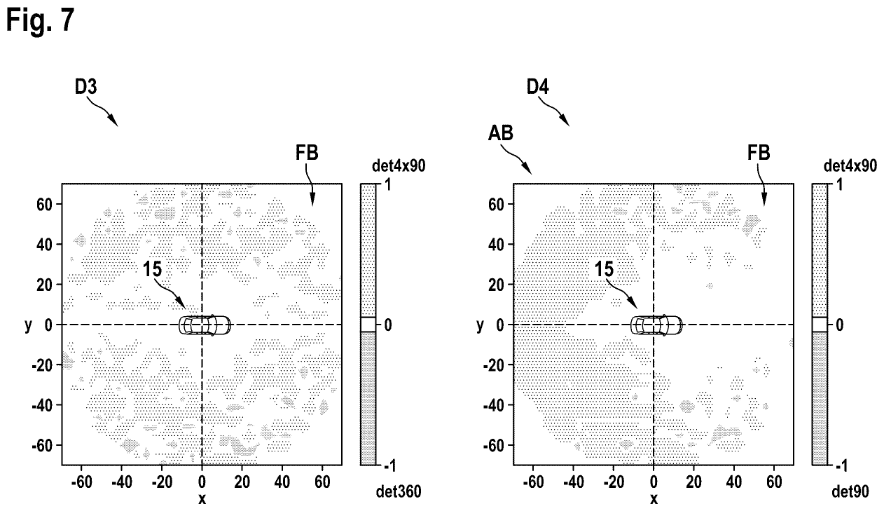

FIG. 7 schematically shows two diagrams D3, D4 for evaluating a detector performance of a third detector DET (“det4x90”) used on the basis of the principle according to the embodiments, as it can be used for n=4 parts RB-1, RB-2, RB-3, RB4 of the spatial region RB of 360°, for example according to the schematic representation of FIG. 5. That is to say, the third detector det4x90 is designed, for example, to evaluate the partial data set TD-1 and the transformed partial data sets TD-2′, TD-3′, TD-4′, which in each case are associated with a corresponding part RB-1, RB-2, RB-3, RB-4 of the spatial region RB.

Diagram D3 shows the detector performance of the third detector det4x90 compared to the first detector det360, and diagram D4 shows the detector performance of the third detector det4x90 compared to the second detector det90.

The shading type assigned to the reference symbol det4x90 indicates spatial regions in which the third detector det4x90 has a higher detector performance according to the mAP metric, and the shading type assigned to the reference symbol det360 (diagram D3) or det90 (diagram D4) indicates spatial regions in which the first detector det360 or the second detector det90 has a higher detector performance according to the mAP metric.

It can be seen from diagram D3 that the third detector det4x90 has a greater mAP metric than the first detector in the entire spatial region of 360°, i.e. the third detector det4x90 is better than the first detector det360 in the entire spatial region of 360°.

It can be seen from diagram D4 that the third detector det4x90 is comparable to the second detector det90 in the frontal region FB with regard to the mAP metric, but is significantly better than the second detector det90 in the other regions AB.

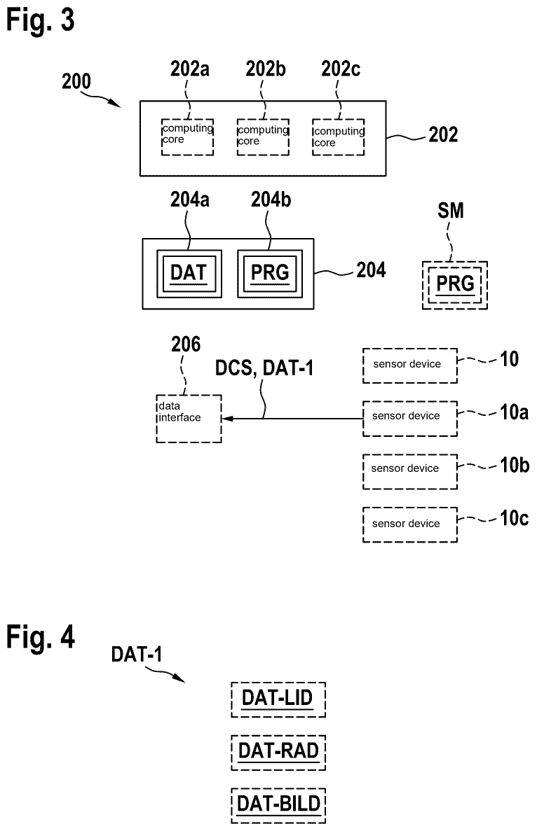

Further exemplary embodiments, FIG. 3, relate to a device 200 for performing the method according to the embodiments.

In further exemplary embodiments, it is provided that the device 200 comprises: a computing device (“computer”) 202 having at least one computing core 202a, 202b, 202c, a memory device 204 assigned to the computing device 202, for at least temporarily storing at least one of the following elements: a) data DAT (for example, the first data DAT-1 or data TD-1, TD-2, . . . , DE-1, DE-2, . . . , DE-2′, DE-3′, . . , derivable therefrom), b) computer program PRG, for example for performing the method according to the embodiments.

In further exemplary embodiments, the memory device 204 has a volatile memory (for example, working memory (RAM) ) 204a, and/or a non-volatile (NVM) memory (for example, flash EEPROM) 204b, or a combination thereof or with other types of memory not explicitly mentioned.

In further exemplary embodiments, the device 200 is designed to realize the function of the detector DET, for example to train and/or evaluate a neural network based on at least one artificial deep neural network, for example of the region proposal network type.

Further exemplary embodiments relate to a computer-readable storage medium SM comprising commands PRG that, when executed by a computer 202, cause said computer to perform the method according to the embodiments.

Further preferred embodiments relate to a computer program PRG comprising commands that, when the program is executed by a computer 202, cause said computer to perform the method according to the embodiments.

Further exemplary embodiments relate to a data carrier signal DCS that transmits and/or characterizes the computer program PRG according to the embodiments.

The data carrier signal DCS can be received, for example, via an optional data interface 206 of the device 200. Likewise, for example, the first data DAT-1 can be transmitted via the optional data interface 206, for example can be received by at least one corresponding sensor device 10, 10a, 10b, 10c. For example, the optional block 10 symbolizes a lidar sensor device, the optional block 10a symbolizes a radar device, the optional block 10b symbolizes a, for example digital, image sensor device, and the optional block 10c symbolizes another sensor device such as a surrounding area sensor device, for example for a vehicle.

Further exemplary embodiments, FIG. 8, relate to a vehicle 15, for example a motor vehicle 15, with at least one device 200 according to the embodiments. Optionally, the vehicle 15 has one or more sensor devices 10, which, for example, provide the first data DAT-1.

In the following, an exemplary processing of the first data DAT-1 of the sensor device 10 of the motor vehicle 15 is described according to further exemplary embodiments. By way of example, it is assumed that the sensor device 10 is designed as a lidar sensor device and that the first data DAT-1 form a point cloud. The lidar data DAT-1 to be processed in the form of a point cloud are partitioned, for example into four parts TD-1, TD-2, TD-3, TD-4, see also FIG. 5, which (for example, except for the first partial data set TD-1) are in each case rotated “forward” around the center point or reference point RP of the lidar sensor device, i.e. in the example according to FIG. 5 into the frontal region FB, for example corresponding to the first part RB-1 of the spatial region RB. The rotation can, for example, be effected similarly to the block 112 according to FIG. 2. For example, each point cloud partition that corresponds to a corresponding partial data set TD-1, TD-2, TD-3, TD-4 is written to a separate batch, such that a batch size of four arises in this case.

A detector DET (FIG. 5) designed, for example, for a spatial region of 90°, is then applied directly, for instance, without any modification, to the rotated point clouds or the partial data sets TD-1, TD-2, TD-3, TD-4 that characterize them, which results in separate (possibly rotated, in the case of the spatial regions RB-2, RB-3, RB-4) detection results DE-1, DE-2, DE-3, DE-4 for each part RB-1, RB-2, RB-3, RB-4.

Since the detection results (“detections”) , for example like the point clouds (with the exception of DE-1) are available individually rotated in four batches, the previous rotation, for example batch by batch, is undone, for example by a new (inverse) rotation. The back-rotated detections DE-2′, DE-3′, DE-4′ for example are then aggregated, for example concatenated, together with the non-rotated detection result DE-1 of the frontal region FB into a single batch, for example a common detection result DE′″.

In further exemplary embodiments, no adjustment whatsoever to the detector DET is provided, such that, for example, a conventional, for example trained, 90° detector of the RPN type can be used to evaluate the various partial data sets TD-1, TD-2, . . . , TD-n. Advantageously, in further exemplary embodiments, for example only modules or computer programs are provided for the described transformations, for example rotations, and reshaping operations (thus, for example, aggregation).

In other words, in further exemplary embodiments, a conventional 90° detector, for example, can be used by the principle according to the embodiments in such a manner that efficient object detection is possible in a larger spatial region RB than corresponds to the region (of 90° in the present case, for example) for which the conventional 90° detector has been designed or trained.

In further exemplary embodiments, the input and output interfaces of the extended detector DET (on the basis of the principle according to the embodiments) remain, for example, unchanged. In addition, in further exemplary embodiments, it is possible to apply the approach, for example of transformation, already during training of the detector. For example, labels can be assigned to the respective partitions or partial data sets TD-1, . . . , TD-n and also rotated accordingly.

In further exemplary embodiments, for example with a radially symmetrical measuring principle of the sensor device 10, as is the case, for example, with the lidar sensor device 10, the partitioning or division can also be undertaken in a manner deviating from the exemplary embodiments mentioned above, and is therefore in particular not restricted to a case of for example 4 partitions or parts RB-1, . . . , RB-4 of the spatial region RB per 90°.

In other exemplary embodiments, for example, other divisions such as 2×180°, 3×120°, up to 360×1° or less (for example, more than 360 partial regions with correspondingl <1°) are also possible and induce, for example, more specialization of the detector in each case.

In other exemplary embodiments, it is also possible to perform division of the parts such that the parts RB-1, . . . , RB-n overlap.

In further exemplary embodiments, the principle according to the embodiments, for example spatial compression, can also be applied to data other than, for example, lidar data. One example is, for example, a radial speed in the case of measured radar locations. This depends for example on the speed of the vehicle 15 to which the radar sensor is fastened. An RPN, for example as a detector for radar data, would not be equivariant with respect to the speed changes of the vehicle. However, analogously to spatial compression according to exemplary embodiments, the radar data in further exemplary embodiments could, for example, be processed (for example compressed) in such a manner that they appear as if they had been recorded when the vehicle was stationary.

In further exemplary embodiments, the principle according to the embodiments, for example spatial compression, can also be applied to a camera image. For example, in further exemplary embodiments, a left-hand half of a camera image can be interpreted as a mirrored version of the right-hand half, for example according to two partial data sets TD-1, TD-2. In further exemplary embodiments, a specialized detector can be trained, for example, on the right-hand side of a camera image and then also applied, for example, to the mirrored left-hand half.

In further exemplary embodiments, a detector capacity saved by the principle according to the embodiments, for example spatial compression, can be used to reduce a number of parameters of a detector DET, for example while maintaining the same performance.

Further exemplary embodiments, FIG. 9, relate to a use 300 of the method according to the embodiments and/or of the device 200 according to the embodiments and/or of the vehicle 15 according to the embodiments and/or of the computer-readable storage medium SM according to the embodiments and/or of the computer program PRG according to the embodiments and/or of the data carrier signal DCS according to the embodiments for at least one of the following elements: a) spatial compression 301, b) specialization 302 of the detector DET, c) saving 303 a capacity of the detector DET, d) reducing 304 network parameters (for example of at least one deep neural network) RPN of the detector DET, for example a reduction of a number of trainable network parameters, for example a number of convolution kernels and/or a number of network levels or layers of the detector DET, e) increasing 305 the performance of the detector DET, f) controlling 306 an overlap of partial data sets TD-1, TD-2, for example with respect to mutually adjacent parts RB-1, RB-2 of the spatial region RB, g) use 307 of a detector DET, for example one that has already been trained, for a spatial region RB larger for example than the spatial region RB for which the detector DET has already been trained, wherein, for example, the detector DET is not changed for use 307, for example is left unchanged, and in particular is not further trained or re-trained, h) recognition 308 of objects, for example for at least one application in vehicles 15, for example driver assistance systems, i) recognition 309 of objects for robotics and/or cyber-physical systems, j) recognition 310 of objects for security technology.

1-15. (canceled)

16. A computer-implemented method for processing first data associated with at least one spatial region, comprising the following steps:
dividing the first data into at least one first partial data set, which is associated with a first part of the spatial region, and a second partial data set, which is associated with a second part of the spatial region, the second part of the spatial region being different at least in regions from the first part of the spatial region;
transforming the second partial data set based on a reference between the second part of the spatial region and the first part of the spatial region, wherein a transformed second partial data set is obtained; and
evaluating the first partial data set and the transformed second partial data set using a detector for object detection.

17. The method according to claim 16, wherein the detector includes at least one artificial neural network.

18. The method according ot claim 17, wherein the artificial neural network is a convolutional neural network (CNN) type or a region proposal network (RPN) type.

19. The method according to claim 16, wherein the first data includes at least one of the following elements: a) data from a lidar sensor device, b) data from a radar sensor device, c) data from an image sensor.

20. The method according to claim 16, further comprising:
transforming a detection result associated with the transformed second partial data set based on the reference between the second part of the spatial region and the first part of the spatial region, wherein a transformed second detection result is obtained.

21. The method according to claim 20, further comprising:
aggregating the transformed second detection result with a first detection result which is associated with the first partial data set.

22. The method according to claim 16, further comprising:
dividing the first data into n many partial data sets, where n>1, which in each case are associated with an n-th part of the spatial region;
transforming a first number N1 of the n many partial data sets, wherein N1 many transformed partial data sets are obtained;
evaluating a first partial data set of the n many partial data sets and at least one transformed partial data set of the NI many transformed partial data sets using the detector.

23. The method according to claim 22, comprising at least one of the following elements: a) transforming detection results associated with the NI many transformed partial data sets, wherein, in each case a transformed second detection result is obtained, b) aggregating the transformed second detection results with a first detection result, which is associated with the first partial data set of the n many partial data sets.

24. The method according to claim 16, wherein the transformation includes a rotation about a reference point of a sensor device providing the first data.

25. The method according to claim 22, wherein the first data associated with the spatial region are associated with an angle of 360°, and wherein each nth part of the spatial region is associated with an angle of 360°/n.

26. A device configured to process first data associated with at least one spatial region, the device configured to:
divide the first data into at least one first partial data set, which is associated with a first part of the spatial region, and a second partial data set, which is associated with a second part of the spatial region, the second part of the spatial region being different at least in regions from the first part of the spatial region;
transform the second partial data set based on a reference between the second part of the spatial region and the first part of the spatial region, wherein a transformed second partial data set is obtained; and
evaluate the first partial data set and the transformed second partial data set using a detector for object detection.

27. A motor vehicle, comprising:
at least one device configured to process first data associated with at least one spatial region, each at least one device configured to:
divide the first data into at least one first partial data set, which is associated with a first part of the spatial region, and a second partial data set, which is associated with a second part of the spatial region, the second part of the spatial region being different at least in regions from the first part of the spatial region,
transform the second partial data set based on a reference between the second part of the spatial region and the first part of the spatial region, wherein
a transformed second partial data set is obtained, and evaluate the first partial data set and the transformed second partial data set using a detector for object detection.

28. A non-transitory computer-readable storage medium on which are stored commands for processing first data associated with at least one spatial region, the commands, when executed by a computer, causing the computer to perform the following steps:
dividing the first data into at least one first partial data set, which is associated with a first part of the spatial region, and a second partial data set, which is associated with a second part of the spatial region, the second part of the spatial region being different at least in regions from the first part of the spatial region;
transforming the second partial data set based on a reference between the second part of the spatial region and the first part of the spatial region, wherein a transformed second partial data set is obtained; and
evaluating the first partial data set and the transformed second partial data set using a detector for object detection.

29. The method according to claim 16, wherein the method is used for at least one of the following elements: a) spatial compression, b) specialization of the detector, c) saving a capacity of the detector, d) reducing network parameters of the detector, e) increasing the performance of the detector, f) controlling an overlap of partial data sets with respect to mutually adjacent parts of the spatial region, g) use of a detector that has already been trained, for a spatial region larger than the spatial region for which the detector has already been trained, wherein, the detector is not changed for use, h) recognition of objects for at least one application in vehicles, i) recognition of objects for robotics and/or cyber-physical systems, j) recognition of objects for security technology.
